(19) United States
(12) Patent Application Publication
(10) Pub. No.: US 2022/0388880 A1
(43) Pub. Date: Dec. 8, 2022

(54) WATER TREATMENT SYSTEM, ULTRAPURE WATER PRODUCING SYSTEM AND WATER TREATMENT METHOD

(71) Applicant: ORGANO CORPORATION, Tokyo (JP)

(72) Inventors: Keisuke SASAKI, Tokyo (JP); Yuki NAKAMURA, Tokyo (JP); Kazushige TAKAHASHI, Tokyo (JP)

(73) Assignee: ORGANO CORPORATION, Tokyo (JP)

(21) Appl. No.: 17/770,185

(22) PCT Filed: Jul. 29, 2020
(86) PCT No.: PCT/JP2020/029085

§ 371 Date: Apr. 19, 2022

(30) Foreign Application Priority Data
Oct. 24, 2019 (JP) 2019-193568

(51) Int. Cl. C02F 9/00; C02F 1/00; B01D 19/00; B01D 61/48; B01D 61/02; B01D 61/54; B01D 61/12

(52) U.S. Cl. CPC C02F 9/00; C02F 1/008; B01D 19/0031; B01D 61/48; B01D 61/026; B01D 61/54; B01D 61/12; B01D 19/0063; C02F 2209/02; C02F 1/4695

(57) ABSTRACT

A water treatment system includes: EDI having deionization chamber that deionizes water that contains boron and concentration chambers in which concentrated water flows; and a cooler to cool the water supplied to deionization chamber or the concentrated water supplied to concentration chambers. Alternatively, water treatment system includes EDI having deionization chamber that deionizes water that contains boron, concentration chambers in which concentrated water flows, and electrode chambers in which electrode water flows; a cooler that adjusts temperature of the water or temperature of the concentrated water supplied to concentration chamber; and a controller that controls the cooler such that the cooler adjusts the temperature of the water supplied to deionization chamber or the temperature of the concentrated water supplied to the concentration chambers within a range of 10-23° C., based on the temperature of the water, temperature of treated water of EDI, the temperature of the concentrated water, or temperature of the electrode water.

### FIELD OF THE INVENTION

The present application is based on, and claims priority from, JP2019-193568, filed on Oct. 24, 2019, and the disclosure of which is hereby incorporated by reference herein in its entirety.

The present invention relates to a water treatment system, an ultrapure water producing system and a water treatment method.

### DESCRIPTION OF THE RELATED ART

Conventionally, in the processes of manufacturing semiconductor devices and liquid crystal devices, pure water (including ultrapure water) from which organic materials, ion components, fine particles, bacteria and so on are substantially removed is used as washing water. In particular, regarding pure water that is used in the processes of washing electronic components including semiconductor devices, the requirements for water quality have been raised year by year. As a part of this, reduction of boron has recently been required. It is known that boron, which is a weak acid, can be removed by means of a reverse-osmosis membrane apparatus (hereinafter, referred to as an RO apparatus) or an electrodeionization apparatus (hereinafter, referred to as an EDI) (JP4045658). In order to substantially remove boron, boron-selective ion exchange resin may also be used.

### SUMMARY OF THE INVENTION

The above-mentioned method needs a system for selectively removing boron and thus results in an increase in initial cost.

The present invention aims at providing a water treatment system and a water treatment method with a simple arrangement to make it possible to enhance the boron removal efficiency of an EDI.

According to an aspect, a water treatment system comprises:

an electrodeionization apparatus having a deionization chamber that deionizes water to be treated that contains boron and a concentration chamber in which concentrated water flows; and

cooling means to cool the water to be treated supplied to the deionization chamber or the concentrated water supplied to the concentration chamber.

According to another aspect, a water treatment system comprises:

an electrodeionization apparatus having a deionization chamber that deionizes water to be treated that contains boron, a concentration chamber in which concentrated water flows, and an electrode chamber in which electrode water flows;

cooling means that adjusts temperature of the water to be treated or temperature of the concentrated water supplied to the concentration chamber; and

control means that controls the cooling means such that the cooling means adjusts the temperature of the water to be treated supplied to the deionization chamber or the temperature of the concentrated water supplied to the concentration chamber within a range of 10 to 23° C., based on the temperature of the water to be treated, temperature of treated water of the electrodeionization apparatus, the temperature of the concentrated water, or temperature of the electrode water.

According to jet another aspect, in a water treatment method using an electrodeionization apparatus comprising a deionization chamber that deionizes water to be treated that contains boron and a concentration chamber in which concentrated water flows, the water treatment method comprises:

cooling the water to be treated or the concentrated water supplied to the concentration chamber by cooling means; and

supplying the water to be treated or the concentrated water to the electrodeionization apparatus after being cooled and deionizing the water to be treated in the deionization chamber.

According to the present invention, it is possible to provide a water treatment system and a water treatment method with a simple arrangement to make it possible to enhance the boron removal efficiency of an EDI.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic view of an ultrapure water producing system according to a first embodiment of the present invention;

FIG. 2A is a view that schematically illustrates an EDI;

FIGS. 2B and 2C are views that schematically illustrate modifications of the EDI shown in FIG. 2A;

FIG. 3 is a schematic view of an ultrapure water producing system according to a second embodiment of the present invention;

FIG. 4 is a schematic view of an ultrapure water producing system according to a third embodiment of the present invention;

FIGS. 5A to 5C are views showing alternative locations of the second heat exchanger;

FIG. 6 is a graph showing the relationship between water temperature and the boron removal rate in Example 1;

FIG. 7 is a graph showing the relationship between water temperature and the voltage of the EDI in Example 2;

FIG. 8A is a graph showing the relationship between water temperature and the voltage of the EDI in Example 3-1;

FIG. 8B is a graph showing the relationship between water temperature and the voltage of the EDI in Example 3-2;

FIG. 9 a graph showing the relationship between water temperature and the boron removal rate in Example 4; and

FIG. 10 is a graph showing the relationship between water temperature and the boron/silica removal rates in Example 5.

### DESCRIPTION OF EMBODIMENTS

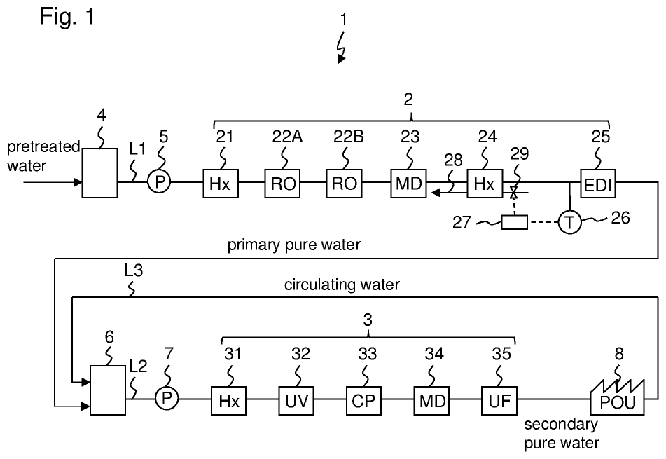

With reference to the drawings, descriptions will now be given of some embodiments of the present invention. FIG. 1 is a schematic view of ultrapure water producing system 1 according to the first embodiment of the present invention. Ultrapure water producing system 1 has a primary pure water producing system (hereinafter, referred to as water treatment system 2) that produces primary pure water from pretreated water and a secondary pure water producing system (hereinafter, referred to as subsystem 3) that is located downstream of water treatment system 2 and that further treats the primary pure water supplied from water treatment system 2 to produce secondary pure water (ultrapure water as treated water). The secondary pure water that is produced by subsystem 3 is supplied to point of use 8. The pretreated water, which is filtered water produced by treating city water etc. by a filter or a sand filter (not illustrated), is stored in filtered water tank 4. The filtered water stored in filtered water tank 4 is supplied to water treatment system 2 by filtered water pump 5. Water that is to be treated by water treatment system 2 and subsystem 3 is referred to as water to be treated. The water to be treated that is treated by water treatment system 2, more specifically, the water to be treated that is supplied to an electrodeionization apparatus, contains boron, and the present invention has a large advantage especially if the boron concentration is 10 ng/L (ppt) or more. In the following descriptions, “upstream” and “downstream” refer to the upstream side and the downstream side, respectively, with regard to the direction in which the water to be treated flows. In subsystem 3, “upstream” and “downstream” are defined not with regard to recirculating line L3 but with regard to second line L2 on which apparatuses are arranged.

In water treatment system 2, first heat exchanger 21, a first reverse-osmosis membrane apparatus (hereinafter, referred to as first RO apparatus 22A), a second reverse-osmosis membrane apparatus (hereinafter, referred to as second RO apparatus 22B), first membrane-degassing apparatus 23, second heat exchanger 24 (means for adjusting water temperature) and an electrodeionization apparatus (hereinafter, referred to as EDI 25) are arranged in a series in the order listed above along first line L1 in which the water to be treated flows and in the direction in which the water to be treated flows from upstream to downstream. Second RO apparatus 22B may be omitted, but by arranging two RO apparatuses in a series, it is possible to lower the conductivity of the water to be treated that is supplied to deionization chamber 43. Either first membrane degassing apparatus 23 or second RO apparatus 22B may be arranged on the upstream side of the other. That is, first membrane degassing apparatus 23 may also be provided between first RO apparatus 22A and second RO apparatus 22B. In this case, second heat exchanger 24 is positioned between second RO apparatus 22B and EDI 25. First heat exchanger 21 adjusts the temperature of the water to be treated that is supplied to first RO apparatus 22A. The viscosity of water is high when the temperature is low and is low when the temperature is high. If water to be treated having a low temperature is supplied to first RO apparatus 22A, then it may be difficult to obtain a desired flow rate because the water to be treated is less apt to pass through the membrane due to high viscosity. The temperature of the water to be treated supplied to first RO apparatus 22A is adjusted to be about 25° C. by first heat exchanger 21. When the temperature of the water to be treated is 25° C. or more at the inlet of first RO apparatus 22A, or when a sufficient pressure of filtered water pump 5 can be ensured to obtain a desired flow rate even if water to be treated having high viscosity passes through the membrane at a low water temperature, first heat exchanger 21 may be omitted. First membrane-degassing apparatus 23 is provided between second RO apparatus 22B and EDI 25 and removes dissolved gas in the water to be treated. The water to be treated is supplied to EDI 25 via second heat exchanger 24. Accordingly, the water to be treated supplied to EDI 25 has been treated by first and second RO apparatuses 22A, 22B and first membrane-degassing apparatus 23, which are provided upstream of EDI 25. When the amount of carbonic acid dissolved in the water to be treated (dissolved carbon dioxide) is limited, or when carbonic acid is removed upstream of first membrane-degassing apparatus 23 by adjusting pH by first RO apparatus 22A etc., the burden of EDI 25 decreases. In these cases, first membrane-degassing apparatus 23 may be omitted, and dissolved gas may be removed by second membrane-degassing apparatus 34 of subsystem 3. Water treatment system 2 may be provided with additional immediate tanks or pumps, as needed.

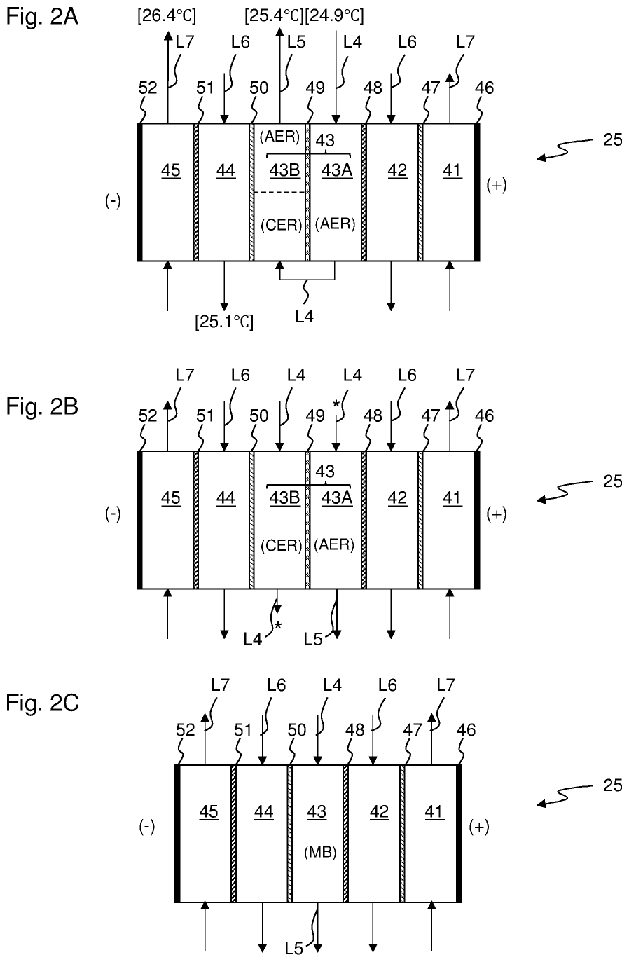

FIG. 2A schematically illustrates the arrangement of EDI 25. EDI 25 has anode chamber 41 that accommodates an anode (not illustrated), cathode chamber 45 that accommodates a cathode (not illustrated), deionization chamber 43 that is positioned between anode chamber 41 and cathode chamber 45 and that deionizes the water to be treated, first concentration chamber 42 that is positioned between anode chamber 41 and cathode chamber 45 and that is adjacent to deionization chamber 43 on the anode side of deionization chamber 43, and second concentration chamber 44 that is adjacent to deionization chamber 43 on the cathode side of deionization chamber 43. First concentration chamber 42 is adjacent to anode chamber 41 via first cation exchange membrane 47, and second concentration chamber 44 is adjacent to cathode chamber 45 via first anion exchange membrane 51. Deionization chamber 43 is adjacent to first concentration chamber 42 via second anion exchange membrane 48 and is adjacent to second concentration chamber 44 via second cation exchange membrane 50. Deionization chamber 43 is divided into first sub-deionization chamber 43A and second sub-deionization chamber 43B in the direction of applying voltage, wherein first sub-deionization chamber 43A and second sub-deionization chamber 43B are separated from each other by an intermediate ion exchange membrane 49 consisting of a cation exchange membrane, an anion exchange membrane, a bipolar membrane, or the like.

EDI 25 is connected to water-to-be-treated line L4 in which the water to be treated flows, treated water line L5 in which the treated water flows, concentrated water line L6 in which the concentrated water flows and electrode water line L7 in which the electrode water flows. Water-to-be-treated line L4 is connected to first sub-deionization chamber 43A. Treated water line L5 is connected to second sub-deionization chamber 43B. Concentrated water line L6 is connected to first concentration chamber 42 and second concentration chamber 44, and electrode water line L7 is connected to anode chamber 41 and cathode chamber 45. Note that water-to-be-treated line L4 corresponds to the portion of first line L1 that is upstream of EDI 25 and to the line that connects first sub-deionization chamber 43A to second sub-deionization chamber 43B, and treated water line L5 corresponds to the portion of first line L1 that is downstream of EDI 25.

First sub-deionization chamber 43A and second sub-deionization chamber 43B are connected to each other in a series via water-to-be-treated line L4 so that the water to be treated flows from first sub-deionization chamber 43A to second sub-deionization chamber 43B. The water to be treated flows in opposite directions (in counter flow) in first sub-deionization chamber 43A and in second sub-deionization chamber 43B. Although not illustrated, more than two deionization chambers may be provided. In this case, concentration chambers are arranged on both sides of each deionization chamber. Specifically, concentration chambers and deionization chambers are alternately arranged between anode chamber 41 and cathode chamber 45, wherein anode chamber 41 and cathode chamber 45 are adjacent to concentration chambers. First cation exchange membrane 47 that separates anode chamber 41 may be omitted so that first concentration chamber 42 also works as anode chamber 41. Similarly, first anion exchange membrane 51 that separates cathode chamber 45 may be omitted so that second concentration chamber 44 also works as cathode chamber 45. In anode chamber 41 and cathode chamber 45, the electrode water flows in the direction opposite that of the concentrated water that flows in first concentration chamber 42 and second concentration chamber 44. In the illustrated example, the electrode water is supplied to anode chamber 41 and cathode chamber 45 in parallel, but, for example, the electrode water that flows out of cathode chamber 45 may be supplied to anode chamber 41.

First sub-deionization chamber 43A is charged with anion exchange resin AER. Second sub-deionization chamber 43B is charged with cation exchange resin CER in the upstream portion thereof in the direction in which the water to be treated flows and is charged with anion exchange resin AER in the downstream portion thereof. Accordingly, the water to be treated flows through anion exchange resin AER, then through cation exchange resin CER, and then through anion exchange resin AER. Such a pattern of charging the chambers with resin is effective for efficiently removing boron contained in the water to be treated. First and second concentration chambers 42, 44 are charged with anion exchange resin in a single bed. The anion exchange resin with which first and second concentration chambers 42, 44 are charged has electrical conductivity, whereby increase in electric resistance between the anode and the cathode is limited. Accordingly, first and second concentration chambers 42, 44 may be charged with cation exchange resin, which is a material having electrical conductivity, in a single bed, or charged with anion exchange resin and cation exchange resin, which are materials having electrical conductivity, in a mixed bed. Although not illustrated, first and second concentration chambers 42, 44 may be charged with ion exchange fiber instead of ion exchange resin. Although first and second concentration chambers 42, 44 are preferably charged with some kind of ion exchange material, this charging with ion exchange material may be omitted if the increase in electric resistance is within an allowable range.

The arrangement of EDI 25 is not limited to that shown in FIG. 2A. For example, as shown in FIG. 2B, second sub-deionization chamber 43B may be charged with cation exchange resin only. In this case, the water to be treated preferably flows in one direction in first sub-deionization chamber 43A and in second sub-deionization chamber 43B. Alternatively, as shown in FIG. 2C, deionization chamber 43 may be a single deionization chamber instead of being divided into sub-deionization chambers. Deionization chamber 43 is charged with anion exchange resin and cation exchange resin in a mixed bed (MB).

Next, second heat exchanger 24 (means for adjusting water temperature) will be described in more detail. Second heat exchanger 24 is provided upstream of EDI 25, specifically, between second RO apparatus 22B and EDI 25, and more specifically, between first membrane-degassing apparatus 23 and EDI 25, and adjusts the temperature of the water to be treated supplied to deionization chamber 43 of EDI 25 within a range of about 10 to 23° C., and preferably 15 to 23° C. By adjusting the temperature of the water to be treated within this range, the boron-removal efficiency of EDI 25 can be enhanced. This point will be described in more detail in the Examples. Since the temperature of the water to be treated is adjusted to about 25° C. at the inlet of first RO apparatus 22A, the water to be treated is cooled by second heat exchanger 24 in the present embodiment. As second heat exchanger 24, heat exchangers of general types such as a shell-and-tube type or a plate type may be used.

Second heat exchanger 24 is connected to cooling line 28 in which cooling water flows, and cooling line 28 is provided with valve 29 that adjusts the flow rate of the cooling water. Thermometer 26 and control means 27 are provided to adjust the temperature. Thermometer 26 is provided on first line L1 between second heat exchanger 24 and EDI 25 and measures the temperature of the water to be treated that is supplied to deionization chamber 43 of EDI 25. Control means 27 controls the degree of opening of valve 29 based on the temperature of the water to be treated that is measured by thermometer 26 so as to adjust the temperature of the water to be treated that is supplied to deionization chamber 43 of EDI 25 within a range of about 10 to 23° C., and preferably 15 to 23° C. In this manner, control means 27 controls the operation of second heat exchanger 24. Control means 27 may be realized by software incorporated into a control computer (not illustrated) of ultrapure water producing system 1. The type of heat exchange is not limited to this form, and any type of heat exchange means, such as an air-cooling type, may be used to adjust the temperature of the water to be treated within the range of 10 to 23° C., and preferably 15 to 23° C. When the temperature of the pretreated water is low or when filtered water pump 5 has sufficient pressure, the temperature of the water to be treated may be less than 25° C. at the inlet of first RO apparatus 22A. In this case, second heat exchanger 24 may also heat the water to be treated. Alternatively, thermometer 26 may be provided at one location selected from among the inlets and the outlets of water-to-be-treated line L4, treated water line L5 and concentrated water line L6, and the inlet and the outlet of electrode water line L7. Thermometer 26 measures the temperature of the water to be treated, the treated water, the concentrated water, or the electrode water, depending on the line on which it is provided. There is a correlation between the temperature of the water to be treated and the temperature of the treated water, and the temperatures of the concentrated water and the electrode water are also correlated with the temperature of the water to be treated. Accordingly, the temperature of the water to be treated for EDI 25 can be controlled regardless of the line among lines L4 to L7 on which thermometer 26 is provided. For example, in Example 4 (having the arrangement shown in FIG. 2A) that is to be described later, when the temperature of the water to be treated was 24.9° C., the temperature of the treated water was 25.4° C., the temperature of the concentrated water was 25.1° C. (at the outlet), and the temperature of the electrode water was 26.4° C. (at the outlet).

As will be described in detail with reference to the Examples, as the temperature of the water to be treated falls, the boron removal rate of EDI 25 uniformly increases. Accordingly, from the viewpoint of the boron removal rate, it is preferable that the temperature of the water to be treated be low. On the other hand, the temperature of the water to be treated in subsystem 3 needs to be adjusted by heat exchanger 31 such that the temperature at the point of use is within a predetermined range. If the temperature of the water to be treated supplied to subsystem 3 is too low, then extra energy will be consumed to heat the water to be treated in subsystem 3. Accordingly, the lower limit of the temperature of the water to be treated supplied to deionization chamber 43 of EDI 25 is preferably about 10° C. Note that, in the present embodiment, water treatment system 2 (second heat exchanger 24) requires energy to cool the water to be treated (for example, the electric energy required to produce cool water), but the temperature of the water to be treated is normally increased by the heat from pure water pump 7 and the like when the water to be treated circulates in the circulating line of subsystem 3 consisting of second line L2 and recirculating line L3. Therefore, cooling the water to be treated by second heat exchanger 24 leads to a decrease in the burden of third heat exchanger 31, and providing second heat exchanger 24 does not cause a large increase in energy for the entire ultrapure water producing system 1.

As will be described in detail in the Examples, by charging first and second concentration chambers 42, 44 with ion exchange resin, the voltage between the anode and the cathode can be kept at a substantially constant level regardless of the temperature and the conductivity of the water to be treated. Accordingly, first and second concentration chambers 42, 44 are preferably charged with ion exchange resin in order to limit the increase in energy consumed in EDI 25 that is caused by cooling the water to be treated that has low conductivity. The conductivity of the water to be treated is limited to about 5 μS/cm or less by arranging two RO apparatuses in a series in the present embodiment.

First membrane-degassing apparatus 23 is provided upstream of second heat exchanger 24. First membrane-degassing apparatus 23 mainly aims at removing dissolved carbon dioxide and dissolved oxygen, and a decrease of the temperature of the water to be treated may lead to deterioration of the de-aerating performance due to increase in the solubility of gas. For this reason, the water to be treated is supplied to first membrane-degassing apparatus 23 before being cooled by second heat exchanger 24.

EDI 25 is connected to subtank 6 that stores the primary pure water. The water treated by EDI 25 (primary pure water) is stored in subtank 6 and is then supplied to subsystem 3 by pure water pump 7. In subsystem 3, third heat exchanger 31, UV oxidization apparatus 32, cartridge polisher 33, second membrane-degassing apparatus 34, and ultrafiltration membrane apparatus 35 are arranged in a series along second line L2 in which the water to be treated flows and in the direction in which the water to be treated flows from upstream to downstream. The secondary pure water produced by subsystem 3 is supplied to point of use 8. The secondary pure water that is not used at point of use 8 is returned to subsystem 3 via recirculating line L3. Recirculating line L3 is connected to subtank 6.

As described above, the temperature of the water to be treated varies due to the heat from pure water pump 7 and the like when the water to be treated circulates in the circulating line of subsystem 3 consisting of second line L2 and recirculating line L3. For this reason, the temperature of the water to be treated is adjusted by third heat exchanger 31. Next, the water to be treated is irradiated with ultraviolet rays by UV oxidization apparatus 32. The total organic carbon (TOC) contained in the water to be treated is resolved into carbon dioxide and organic acid by OH radicals generated by the irradiation with ultraviolet rays. The water to be treated is further supplied to cartridge polisher 33 where ion components are removed. Cartridge polisher 33 is a non-regenerative ion exchange apparatus, which is a cylinder charged with ion exchange resin. The water to be treated that has passed through cartridge polisher 33 is then supplied to second membrane-degassing apparatus 34 where dissolved oxygen is removed. Further, fine particles contained in the water to be treated are removed by the ultrafiltration membrane apparatus, whereby production of the secondary pure water is completed. The secondary pure water thus produced is supplied to point of use 8.

### Second Embodiment

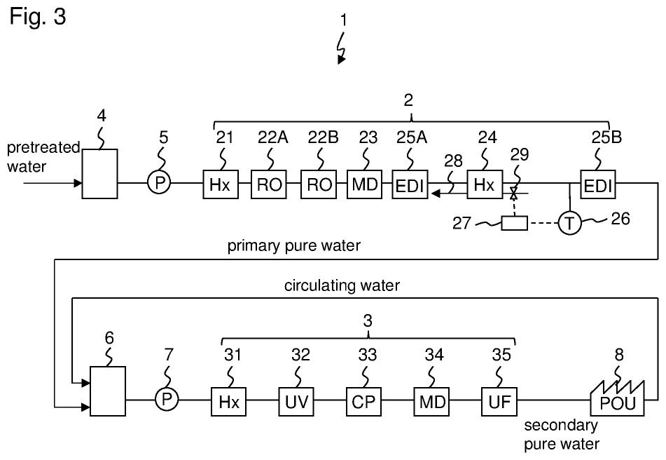

FIG. 3 schematically illustrates the arrangement of ultrapure water producing system 1 according to the second embodiment of the present invention. Differences from the first embodiment will be mainly described here. Arrangements not described here are the same as in the first embodiment. In the present embodiment, two EDIs are arranged in a series, wherein an upstream EDI is added to the first embodiment. The downstream EDI may be the same as or may be different from EDI 25 of the first embodiment. In the following description, the upstream EDI is referred to as first EDI 25A, and the EDI provided downstream of first EDI 25A is referred to as second EDI 25B. The water to be treated for second EDI 25B is the treated water of first EDI 25A. By arranging two EDIs in a series, the water quality of the primary pure water can be further improved. The conductivity of the treated water of first EDI 25A is reduced to 0.055 to 0.10 μS/cm (about 10.0 to 18.2 MΩ·cm in specific resistance), and the boron concentration is reduced to about 10 to 100 ng/L. Second heat exchanger 24 is positioned between first EDI 25A and second EDI 25B. The provision of a downstream heat exchanger reduces the flow rate to be treated and the size of the heat exchanger can therefore be reduced. In addition, as will be described later, the removal rate of silica can be assumed to decrease as the water temperature falls. Since an EDI has a higher removal rate for silica than for boron, it is preferable that the water temperature be lowered after a certain amount of silica has been removed by upstream first EDI 25A.

### Third Embodiment

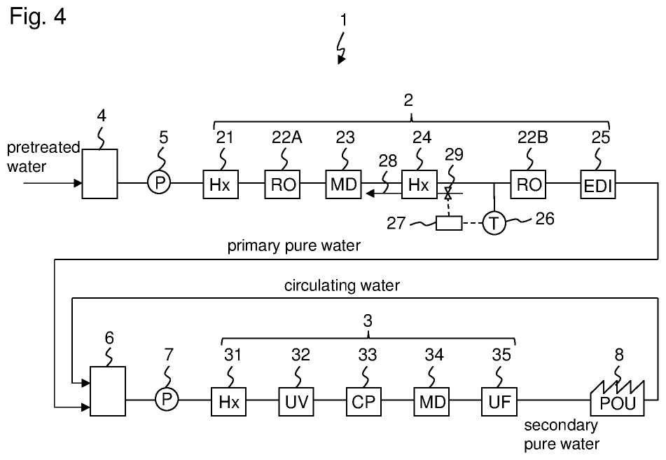

FIG. 4 schematically illustrates the arrangement of ultrapure water producing system 1 according to the third embodiment of the present invention. Differences from the first embodiment will be mainly described here. Arrangements not described here are the same as in the first embodiment. In the present embodiment, second heat exchanger 24 is provided between first RO apparatus 22A and second RO apparatus 22B. First membrane-degassing apparatus 23 is provided between first RO apparatus 22A and second heat exchanger 24 because the de-aerating efficiency is improved by treating the water to be treated before cooling, as described above.

The boron removal rate of an RO apparatus is improved when the temperature of the water to be treated is low. On the other hand, ions are concentrated on the primary side (inlet side) of an RO apparatus. Thus, when the water to be treated is supplied to an RO apparatus at a low temperature, the solubility of each ion component decreases on the primary side of the RO apparatus, and precipitation of ions may occur. In particular, this tendency is greater on the primary side of first RO apparatus 22A where the ion concentration is high. However, the possibility of precipitation of ions is small on the primary side of second RO apparatus 22B because the concentration of ion components is low. The possibility of precipitation of ions can be limited by supplying the water to be treated to first RO apparatus 22A at a relatively high temperature, while the boron removal rate can be enhanced by supplying the water to be treated to second RO apparatus 22B at a relatively low temperature.

(Modifications)

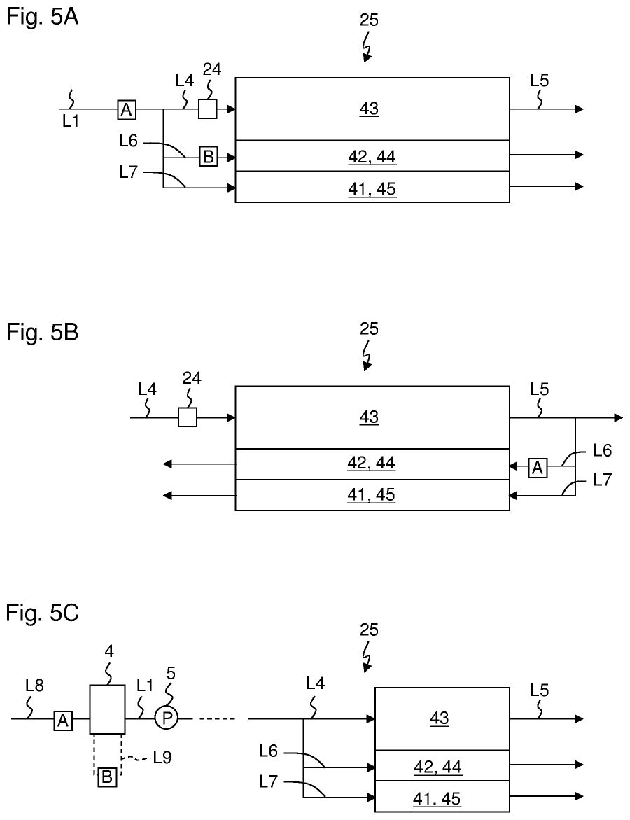

Second heat exchanger 24 is provided on water-to-be-treated line L4 downstream of the branching point where concentrated water line L6 and electrode water line L7 branch off but may be provided at other locations. As shown in FIG. 5A, second heat exchanger 24 may be provided on water-to-be-treated line L4 upstream of the branching point (i.e., at point A in the drawing) or on concentrated water line L6 (at point B in the drawing). In an arrangement where the treated water of the EDI is used as the concentrated water and the electrode water, second heat exchanger 24 may be provided on concentrated water line L6 (at point A in the drawing) instead of on water-to-be-treated line L4, as shown in FIG. 5B. When second heat exchanger 24 is provided on concentrated water line L6 as in these cases, the temperature of the concentrated water falls. For this reason, the occurrence of spread in concentration from concentration chambers 42, 44 to deionization chamber 43 is suppressed, and the boron removal efficiency is enhanced. The temperature of the concentrated water supplied to concentration chambers 42, 44 is adjusted within the range of about 10 to 23° C., and preferably 15 to 23° C., in the same manner as the water to be treated. As shown in FIG. 5C, second heat exchanger 24 may also be provided on pretreated water supply line L8 upstream of filtered water tank 4 (at point A in the drawing). Alternatively, circulating line L9 having second heat exchanger 24 may be connected to filtered water tank 4 (point B in the drawing) so as to directly cool the filtered water (pretreated water) stored in filtered water tank 4. Note that concentration chambers 42, 44 and electrode chambers 41, 45 are both depicted as single chambers in FIG. 5.

### Examples

Some tests were conducted using EDI 25 (hereinafter, simply referred to as an EDI) shown in FIG. 2A. Each test is summarized in Table 1.

TABLE 1

| | | | | | |
|---|---|---|---|---|---|
| Example 1 | Example 2 | Example 3-1 | Example 3-2 | Example 4 | Example 5 |

| Water to be treated | Item | Two ROs filtered water | Two ROs filtered water | Two ROs filtered water | |
|---|---|---|---|---|---|
| | | | Two ROs filtered water, | | |
| | | | and NaCl added | | |
| | Boron concentration | 20~100 | | 5~20 | 10~20 |
| | (μg/L) | | | | |
| | Silica concentration | | | 5~20 | 50~100 |
| | (μg/L) | | | | |
| | Conductivity | 0.3~0.4 | 0.4*¹ | 1.0~1.5 | 3.0~5.0 |
| | (μS/cm) | | 3.6*² | | |

| EDI arrangement | Deionization chamber | FIG. 2C | FIG. 2A | FIG. 2B |
|---|---|---|---|---|
| | arrangement | | | |
| | Chamber size (cm) | 10 × 10 × 1 | 15 × 28 × 1 | |
| | No. of ionization | 1 | 5 | |
| | chambers | | | |
| Resin with which | Ionization chamber | MB | First sub deionization | First sub deionization |
| EDI is charged | | | chamber: AER | chamber: AER |
| | | | Second sub: deionization | Second sub: deionization |
| | | | chamber: CER/AER | chamber: CER |

| | | | | | |
|---|---|---|---|---|---|
| Concentration chamber | AER | No resin | AER | No resin | AER |

| | Anode chamber | CER | | |
|---|---|---|---|---|
| | Cathode chamber | AER | | |
| Operating condition | Flow rate of treated | 10 | 500 | 750 |
| | water (L/h) | | | |
| | Flow rate of | 5 | 50 | 75 |
| | concentrated water | | | |
| | (L/h) | | | |
| | Flow rate of electrode | 5 | 18 | 18 |
| | water (L/h) | | | |
| | Current (A) | 0.1 | 5 | 2.5 |
| | Current density | 0.1 | 1.2 | 0.6 |
| | (A/dm²) | | | |

MB: Mix bed of anion exchange resin and cation exchange resin, AER: single bed of anion exchange resin, CER: single bed of cation exchange resin
*¹Water to be treated is two ROs filtered water
*²Water to be treated is two ROs filtered water and NaCl added

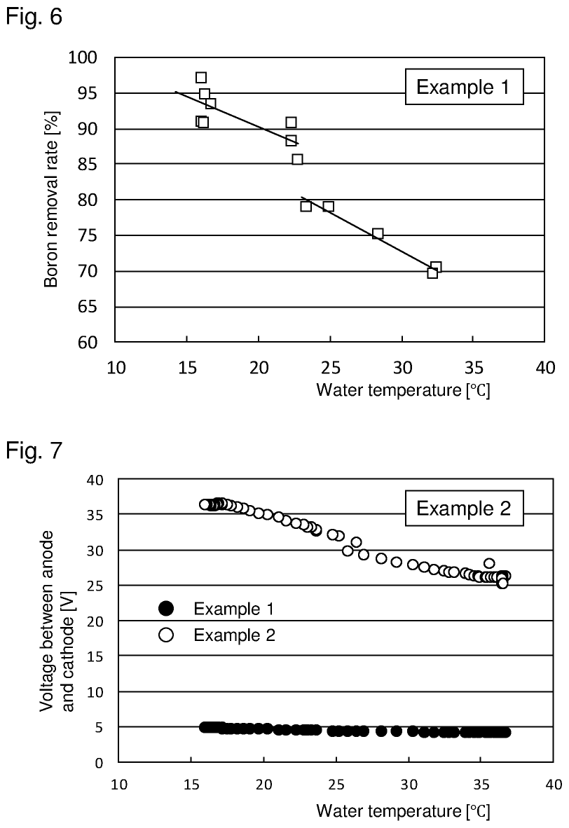

In Example 1, the boron removal rate of the EDI was obtained for various temperatures of the water to be treated supplied to the EDI. FIG. 6 shows the results. The boron removal rate increased as water temperature fell. In particular, the boron removal rate sharply increased at 23° C., and a boron removal rate of 85% or more was achieved at a water temperature of 23° C. or lower. Based on the straight approximation line shown in FIG. 6, the boron removal rate is 88.5% at a water temperature of 22° C., and the boron removal rate is 89.4% at a water temperature of 21° C. Furthermore, the boron removal rate is 72.8% at a water temperature of 30° C., and the boron removal rate is 73.9% at a water temperature of 29° C. From these results, it can be concluded that a decrease of 1° C. in the water temperature causes an increase of about 1% in the boron removal rate. Therefore, it is preferable to cool the water to be treated supplied to the EDI such that the water temperature after cooing is at least 1° C. lower than the water temperature before cooling. As described in the above modifications, in a case in which the concentrated water supplied to first and second concentration chambers 42, 44 is cooled, a similar effect is obtained by cooling the concentrated water supplied to first and second concentration chambers 42, 44 such that the water temperature is lowered by at least 1° C.

Next, the relationship between whether first and second concentration chambers 42, 44 (hereinafter, simply referred to as concentration chambers) were charged with ion exchange resin or not and the voltage between the anode and the cathode was investigated. FIG. 7 shows the results. Example 2 and Example 1 are identical with the exception that the concentration chambers are not charged with anion exchange resin. In Example 2, the voltage increases as the temperature of the water to be treated supplied to the EDI decreases. That is, when the temperature of the water to be treated supplied to the EDI is lowered in order to enhance the boron removal efficiency, energy consumption increases. On the other hand, in Example 1, the voltage is constant regardless of the temperature of the water to be treated supplied to the EDI. Lowering the temperature of the water to be treated supplied to the EDI to improve the boron removal efficiency does not cause an increase in energy consumption. Further, Example 1 shows a lower voltage, and the energy consumption in Example 1 is less than that of Example 2. Accordingly, from the viewpoint of energy efficiency, it is advantageous to charge the concentration chambers with ion exchange resin.

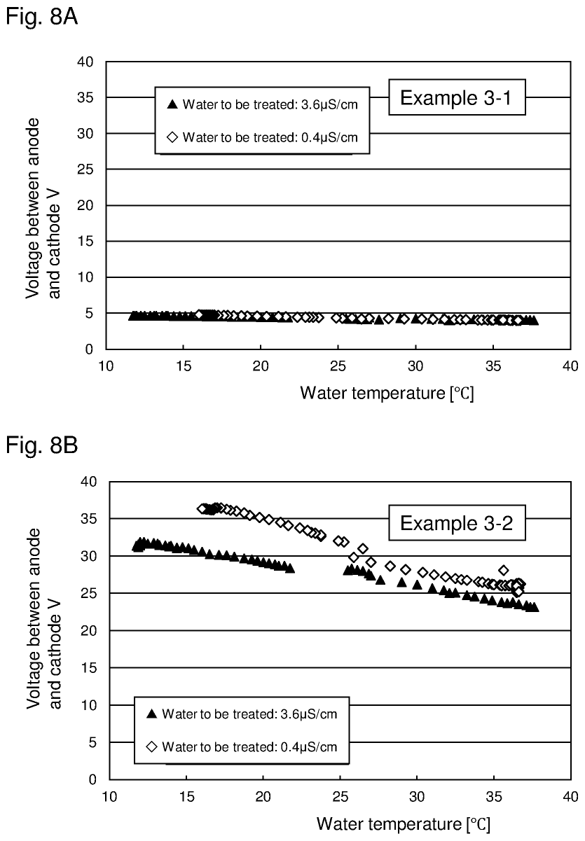

Next, the relationship among the conductivity of the water to be treated, whether the concentration chambers are charged with ion exchange resin or not, and the voltage between the anode and the cathode was investigated. FIGS. 8A, 8B show the results. Example 3 consists of Example 3-1 and Example 3-2, wherein the concentration chambers are charged with anion exchange resin, as in Example 1, in Example 3-1, and the concentration chambers are not charged with ion exchange resin, as in Example 2, in Example 3-2. In Examples 3-1 and 3-2, the water used as the water to be treated was: filtered water that has passed through two stages of ROs (low conductivity); and filtered water that has passed through two stages of ROs and to which NaCl is subsequently added (high conductivity). In Example 3-1 (FIG. 8A), the voltage is kept low regardless of the conductivity of the water to be treated and the temperature of the water to be treated supplied to the EDI. In Example 3-2 (FIG. 8B), substantially the same result as Example 2 was obtained, but the water to be treated that has low conductivity tends to show a larger voltage than the water to be treated that has high conductivity. Therefore, in order to produce ultrapure water having a low boron concentration at high energy efficiency, it is advantageous to charge the concentration chambers with ion exchange resin.

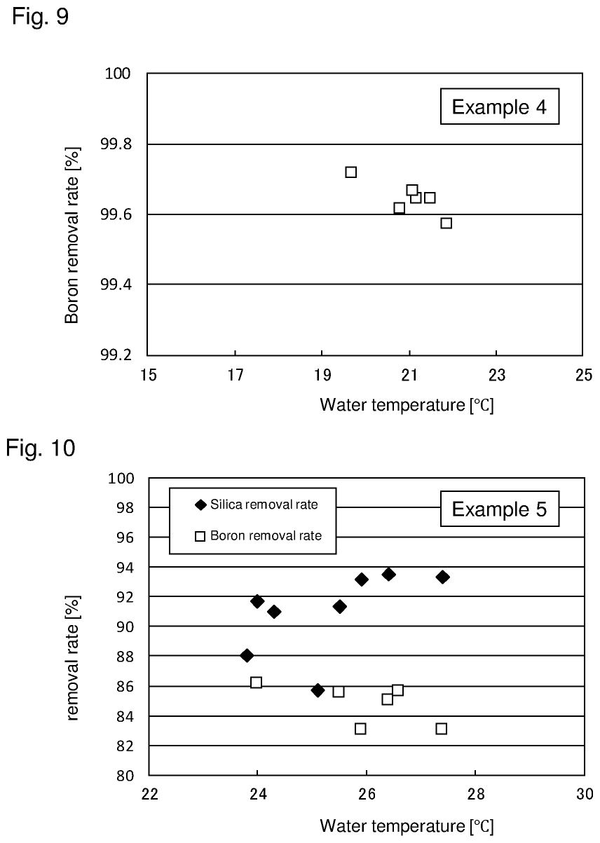

In Examples 1 to 3, single deionization chamber 43 is charged with resin in a mixed bed. Thus, Examples 4, 5 are conducted in order to confirm that similar effects can be achieved for other arrangements of deionization chamber 43 and for other resin charging patterns. The arrangement of deionization chamber 43 and the resin charging pattern in Example 4 are shown in FIG. 2A. Deionization chamber 43 is partitioned into two sub-deionization chambers, with one of the chambers charged with anion exchange resin and the other being charged with cation exchange resin and anion exchange resin. The arrangement of deionization chamber 43 and the resin charging pattern in Example 5 are shown in FIG. 2B. Deionization chamber 43 is partitioned into two sub-deionization chambers, with one of the chambers charged with anion exchange resin and the other being charged with cation exchange resin. In the same manner as Example 1, the boron removal rate of the EDI was obtained for various temperatures of the water to be treated supplied to the EDI. FIG. 9 shows the results of Example 4, and FIG. 10 shows the results of Example 5. The boron removal rate increased as the water temperature decreased, and the same results as Example 1 were obtained. In Example 4, the boron removal rate is 99.7% when water temperature is 19.7° C. Based on these results, the temperature of the water to be treated that is supplied to the deionization chamber of the EDI is preferably adjusted within the range of about 10 to 19.7° C., and more preferably 15 to 19.7° C. In Example 5, the silica removal rate was also obtained. The silica removal rate decreases as the water temperature falls, opposite to the boron removal rate. In order to limit the influence of silica, the concentration of silica contained in the water to be treated is desirably as low as possible, for example, preferably 100 μg/L(ppb) or less.

Although certain preferred embodiments of the present invention have been shown and described in detail, it should be understood that various changes and modifications may be made without departing from the spirit or scope of the appended claims.

### LIST OF REFERENCE NUMERALS

1 ultrapure water producing system
2 water treatment system
3 subsystem
8 point of use
22A first RO apparatus (first reverse-osmosis membrane apparatus)
22B second RO apparatus (second reverse-osmosis membrane apparatus)
23 first membrane-degassing apparatus
24 heat exchange means (second heat exchanger)
25 EDI (electrodeionization apparatus)
25A first EDI (first electrodeionization apparatus)
25B second EDI (second electrodeionization apparatus)
26 thermometer
27 control means
41 anode chamber (electrode chamber)
42 first concentration chamber
43 deionization chamber
43A first sub-deionization chamber
43B second sub-deionization chamber
44 second concentration chamber
45 cathode chamber (electrode chamber)
L1 first line
L2 second line
L3 recirculating line

1.-17. (canceled)

18. A water treatment system comprising:
an electrodeionization apparatus having a deionization chamber that deionizes water to be treated that contains boron and a concentration chamber in which concentrated water flows; and
a cooler to cool the water to be treated supplied to the deionization chamber or the concentrated water supplied to the concentration chamber and
a controller that controls the cooler such that the cooler adjusts the temperature of the water to be treated supplied to the deionization chamber or the temperature of the concentrated water supplied to the concentration chamber within a range of 10 to 23° C., based on the temperature of the water to be treated, temperature of treated water of the electrodeionization apparatus, or the temperature of the concentrated water.

19. The water treatment system according to claim 18, wherein the cooler cools the water to be treated or the concentrated water such that temperature thereof is lowered at least 1° C.

20. A water treatment system comprising:
an electrodeionization apparatus having a deionization chamber that deionizes water to be treated that contains boron, a concentration chamber in which concentrated water flows, and an electrode chamber in which electrode water flows;
a cooler that adjusts temperature of the water to be treated or temperature of the concentrated water supplied to the concentration chamber; and
a controller that controls the cooler such that the cooler adjusts the temperature of the water to be treated supplied to the deionization chamber or the temperature of the concentrated water supplied to the concentration chamber within a range of 10 to 23° C., based on the temperature of the water to be treated, temperature of treated water of the electrodeionization apparatus, the temperature of the concentrated water, or temperature of the electrode water.

21. The water treatment system according to claim 20, further comprising:
a water-to-be-treated line connected to the electrodeionization apparatus, wherein the water to be treated flows in the water-to-be-treated line;
a treated water line connected to the electrodeionization apparatus, wherein the treated water flows in the treated water line;
a concentrated water line connected to the electrodeionization apparatus, wherein the concentrated water flows in the concentrated water line;
an electrode water line connected to the electrodeionization apparatus, wherein the electrode water flows in the electrode water line; and
a thermometer that is provided on one selected from among the water-to-be-treated line, the treated water line, the concentrated water line and the electrode water line, wherein the thermometer measures the temperature of the water to be treated, the treated water, the concentrated water or the electrode water.

22. The water treatment system according to claim 21, wherein the thermometer is provided between the cooler and the electrodeionization apparatus, and the thermometer measures the temperature of the water to be treated.

23. The water treatment system according to claim 18, further comprising a reverse-osmosis membrane apparatus that is provided upstream of the electrodeionization apparatus, wherein the cooler is positioned between the reverse-osmosis membrane apparatus and the electrodeionization apparatus.

24. The water treatment system according to claim 23, wherein the reverse-osmosis membrane apparatus is a first reverse-osmosis membrane apparatus,
further comprising a second reverse-osmosis membrane apparatus that is provided downstream of the first reverse-osmosis membrane apparatus and upstream of the electrodeionization apparatus, wherein the cooler is positioned between the first reverse-osmosis membrane apparatus and the second reverse-osmosis membrane apparatus.

25. The water treatment system according to claim 23, further comprising a membrane-degassing apparatus that is provided between the reverse-osmosis membrane apparatus and the electrodeionization apparatus, wherein the cooler is positioned between the membrane-degassing apparatus and the electrodeionization apparatus.

26. The water treatment system according to claim 23, wherein the reverse-osmosis membrane apparatus is a first reverse-osmosis membrane apparatus,
further comprising:
a second reverse-osmosis membrane apparatus that is provided downstream of the first reverse-osmosis membrane apparatus; and
a membrane-degassing apparatus that is provided downstream of the second reverse-osmosis membrane apparatus and upstream of the electrodeionization apparatus, wherein
the cooler is positioned between the membrane-degassing apparatus and the electrodeionization apparatus.

27. The water treatment system according to claim 23, wherein the reverse-osmosis membrane apparatus is a first reverse-osmosis membrane apparatus,
further comprising:
a membrane-degassing apparatus that is provided downstream of the first reverse-osmosis membrane apparatus; and
a second reverse-osmosis membrane apparatus that is provided downstream of the membrane-degassing apparatus and upstream of the electrodeionization apparatus, wherein
the cooler is positioned between the second reverse-osmosis membrane apparatus and the electrodeionization apparatus.

28. The water treatment system according to claim 18, wherein the electrodeionization apparatus is a second electrodeionization apparatus,
further comprising a first electrodeionization apparatus that is provided upstream of the second electrodeionization apparatus, wherein
the cooler is positioned between the first electrodeionization apparatus and the second electrodeionization apparatus.

29. The water treatment system according to claim 18, wherein concentration of the boron contained in the water to be treated is 10 ng/L or more.

30. The water treatment system according to claim 18, wherein the concentration chamber is charged with ion exchange material.

31. An ultrapure water producing system comprising:
the water treatment system according to claim 18;
a subsystem that is positioned downstream of the water treatment system, wherein the subsystem further treats treated water supplied from the water treatment system as water to be treated and supplies treated water to a point of use; and
a recirculating line that returns treated water that is not used at the point of use back to the subsystem.

32. A water treatment method using an electrodeionization apparatus comprising a deionization chamber that deionizes water to be treated that contains boron and a concentration chamber in which concentrated water flows, the water treatment method comprising:
cooling the water to be treated or the concentrated water supplied to the concentration chamber by a cooler; and
supplying the water to be treated or the concentrated water to the electrodeionization apparatus after being cooled and deionizing the water to be treated in the deionization, wherein
the temperature of the water to be treated supplied to the deionization chamber or the temperature of the concentrated water supplied to the concentration chamber is adjusted within a range of 10 to 23° C., based on the temperature of the water to be treated, temperature of treated water of the electrodeionization apparatus, or the temperature of the concentrated water.

33. A water treatment method using an electrodeionization apparatus comprising a deionization chamber that deionizes water to be treated that contains boron, a concentration chamber in which concentrated water flows, and an electrode chamber in which electrode water flows the water, treatment method comprising:
cooling the water to be treated or the concentrated water supplied to the concentration chamber by a cooler; and
supplying the water to be treated or the concentrated water to the electrodeionization apparatus after being cooled and deionizing the water to be treated in the deionization chamber, wherein
the temperature of the water to be treated supplied to the deionization chamber or the temperature of the concentrated water supplied to the concentration chamber is adjusted within a range of 10 to 23° C., based on the temperature of the water to be treated, temperature of treated water of the electrodeionization apparatus, the temperature of the concentrated water, or temperature of the electrode water.

34. The water treatment method according to claim 32, wherein concentration of the boron contained the water to be treated is 10 ng/L or more.

35. The water treatment method according to 32, wherein conductivity of the water to be treated supplied to the deionization chamber is 5 μS/cm or less.
